(19) United States
(12) Patent Application Publication
(10) Pub. No.: US 2024/0101202 A1
(43) Pub. Date: Mar. 28, 2024

(54) STAIR-CLIMBING VEHICLE

(71) Applicants: HYUNDAI MOTOR COMPANY, Seoul (KR); KIA CORPORATION, Seoul (KR)

(72) Inventors: Jong Sool Park, Hwaseong-si (KR); Jong Chan Park, Seongnam-si (KR)

(73) Assignees: HYUNDAI MOTOR COMPANY, Seoul (KR); KIA CORPORATION, Seoul (KR)

(21) Appl. No.: 18/118,940

(22) Filed: Mar. 8, 2023

(30) Foreign Application Priority Data
Sep. 28, 2022 (KR) 10-2022-0123525

(51) Int. Cl. B62D 57/02

(52) U.S. Cl. CPC B62D 57/022

(57) ABSTRACT

A vehicle includes: a body, a plurality of driving wheels arranged along a front-rear direction of the body to be rotatable and movable with respect to the body, a wheel position moving device for moving a rotation shaft of the driving wheel while preventing the driving wheel from contacting a stair vertical plane, and a driving source installed to supply driving force to the driving wheel.

### CROSS REFERENCE TO RELATED APPLICATION

The present application claims priority to Korean Patent Application No. 10-2022-0123525, filed Sep. 28, 2022, the entire contents of which is incorporated herein for all purposes by this reference.

### BACKGROUND

### Field

The present disclosure relates to a vehicle capable of climbing stairs.

### Description of the Related Art

It is common for roads and buildings to have stairs for pedestrians.

Recently, it has been considered desirable that various vehicles not only travel on a simple road but also travel on stairs if possible.

In other words, it is desirable that Last Mile Mobile and Last Mile Delivery vehicles for delivering goods to the front of the recipient's door, as well as vehicles for the disabled such as wheelchairs, can smoothly and uninterruptedly climb the stairs.

The foregoing is intended merely to aid in the understanding of the background of the present disclosure, and is not intended to mean that the present disclosure falls within the purview of the related art that is already known to those having ordinary skill in the art.

### SUMMARY OF THE PRESENT DISCLOSURE

It is an object of the present disclosure to provide a stair-climbing vehicle configured to ascend and descend stairs in a smooth and uninterrupted manner as well as to travel on flat roads and can be used as vehicles for the disabled, Last Mile Mobile, Last Mile Delivery, etc. thereby making human life more convenient in buildings including stairs.

In order to accomplish the above object, a stair-climbing vehicle in an embodiment of the present disclosure includes: a body, and a plurality of driving wheels arranged along a front-rear direction of the body to be rotatable and movable with respect to the body. The stair-climbing vehicle further includes: a wheel position moving device for moving a rotation shaft of the driving wheel while preventing the driving wheel from contacting a stair vertical plane, and a driving source installed to supply driving force to the driving wheel.

The driving wheels may be arranged in pairs for two driving wheels to simultaneously contact a same stair horizontal plane along a front-rear direction of the body.

The pair of two driving wheels arranged to simultaneously contact the same stair horizontal plane may have different separation distances from a front-rear center line of the body to rotation axes thereof.

The pair of two driving wheels arranged to simultaneously contact the same stair horizontal plane may at least partially overlap each other when viewed in a lateral direction of the body.

At least two couples of pairs of two driving wheels arranged to simultaneously contact the same stair horizontal plane may be disposed along the front-rear direction of the body.

The wheel position moving device may be provided to move the rotation shafts of the driving wheels independently from each other.

The driving wheels may be provided symmetrically on both sides with respect to the front-rear center line of the body.

The driving source may include a motor disposed in the driving wheels.

The driving source may include a motor disposed in the body.

The wheel position moving device may be connected to a wheel support device supporting the driving wheel to continuously transmit driving force from the motor to the driving wheel while the rotation shaft of the driving wheel is moving, wherein the wheel support device may include a ring gear installed concentrically to the driving wheel, a sun gear installed in the ring gear to receive driving force from the motor, a gear train configured to allow relative motion between the rotation shafts of the sun gear and the ring gear and to form a continuous driving force transmission state between the sun gear and the ring gear, and a carrier constituting the gear train and constantly supporting positions of the rotation shaft of a final pinion engaged with the ring gear with respect to the position of the rotation shaft of the ringer gear.

The gear train may be provided with a plurality of links connected to each other to form an angle varying according to a relative motion between the rotation shafts of the sun gear and the ring gear, the plurality of links may include a first link connected to the rotation shaft of the sun gear and a second link connected to the first link, and a joint pinion having a same number of teeth as the sun gear may be installed at a connection point of the first and second links.

The second link may be provided with a final pinion engaged with the ring gear, the final pinion may have the same number of teeth as the sun gear and may be configured to transmit a driving force from the sun gear to the ring gear via a series of gears connected to the joint pinion.

The gear train may be provided in plurality along a circumferential direction of the sun gear.

The gear train may be provided with a plurality of links connected to each other to form an angle varying according to a relative motion between the rotation shafts of the sun gear and the ring gear, the plurality of links may include a first link connected to the rotation shaft of the sun gear and a second link connected to the first link, and the first and second links may be provided with rotation shafts of a series of gears to transmit driving force from the sun gear to the ring gear.

The series of gears constituting the gear train may include gears positioned at even-numbered positions from the sun gear and having a same number of teeth as the sun gear.

The gear positioned second from the sun gear may be a joint pinion installed concentrically with the rotation shaft of the first and second links, and the gear positioned fourth from the sun gear may be the final pinion engaged with the ring gear.

The sun gear and the joint pinion may be engaged with a first intermediate pinion having a rotation shaft installed on the first link, and the joint pinion and the final pinion gear may be engaged with a second pinion having a rotation shaft installed on the second link.

The gear train may be provided in plurality along a circumferential direction of the sun gear, and the final pinions of the gear trains may be supported by the carrier to keep relative positions constantly and allowed only to rotate.

The gear train may be configured to constantly maintain relative phases of the sun gear and the ring gear with respect to relative motions of the rotation shafts of the sun gear and the ring gear.

In another embodiment of the present disclosure, the stair-climbing vehicle includes: a body, and a plurality of driving wheels arranged in pairs, rotatably and movably with respect to the body, for two paired driving wheels to simultaneously contact the same stair plane along a front-rear direction of the body. The stair-climbing vehicle further includes: a wheel position moving device provided to actively move rotation shafts of the driving wheels with respect to the body, and a driving source installed to supply driving force to the driving wheels.

The present disclosure is advantageous in terms of making human life more convenient in buildings including stairs by providing a stair-climbing vehicle that is configured to ascend and descend stairs in a smooth and uninterrupted manner as well as to travel on flat roads and can be used as vehicles for the disabled, Last Mile Mobile, Last Mile Delivery, etc.

### BRIEF DESCRIPTION OF THE DRAWINGS

FIG. 1 is a view for describing a situation in which a stair-climbing vehicle according to an embodiment of the present disclosure climbs stairs;

FIG. 2 is an observation view in direction II in FIG. 1;

FIG. 3 is an observation view in direction III of FIG. 1;

FIG. 4 is a view illustrating a wheel position moving device in an embodiment of the present disclosure;

FIG. 5 is a view illustrating a wheel support device in an embodiment of the present disclosure;

FIG. 6 is a view illustrating a change in a wheel support device when a driving wheel is lowered by a wheel position moving device in an embodiment of the present disclosure;

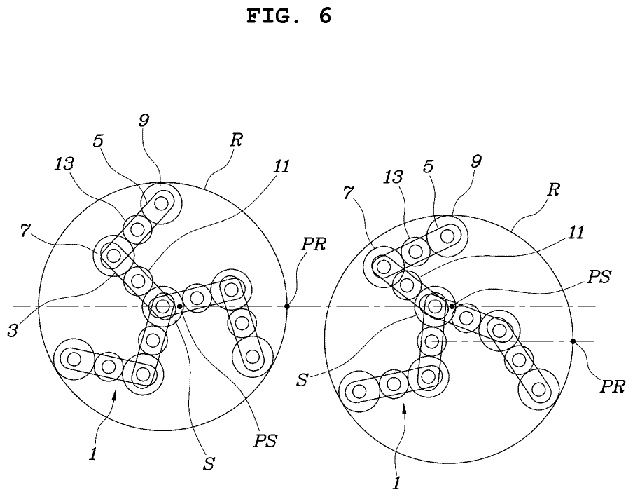

FIG. 7 is a view illustrating a change of a wheel support device when a driving wheel is raised by a wheel position moving device in an embodiment of the present disclosure; and

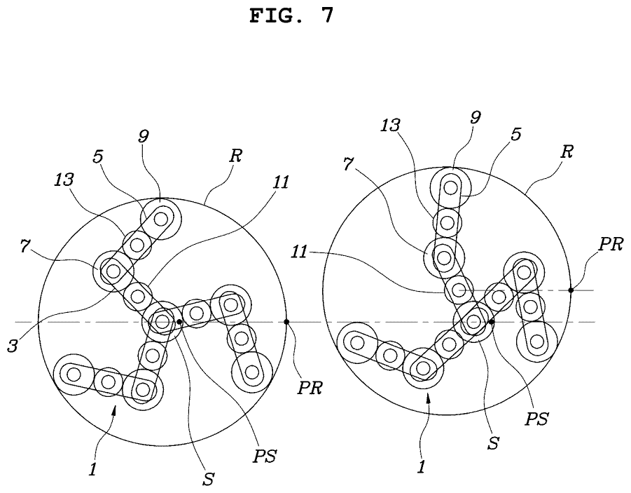

FIG. 8 is a diagram conceptually illustrating a main configuration when a driving source is a motor in an embodiment of the present disclosure.

### DETAILED DESCRIPTION OF THE PRESENT DISCLOSURE

Hereinafter, descriptions are made of the embodiments disclosed in the present specification with reference to the accompanying drawings in which the same reference numbers are assigned to refer to the same or like components and redundant description thereof is omitted.

As used in the following description, the suffix “module” and “unit” are granted or used interchangeably in consideration of easiness of description but, by itself, having no distinct meaning or role.

In addition, detailed descriptions of well-known technologies related to the embodiments disclosed in the present disclosure may have been omitted to avoid obscuring the subject matter of the embodiments disclosed in the present disclosure. In addition, the accompanying drawings are only for easy understanding of the embodiments disclosed in the present disclosure and do not limit the technical sprit disclosed herein, and it should be understood that the embodiments include all changes, equivalents, and substitutes within the sprit and scope of the present disclosure.

As used herein, terms including an ordinal number such as “first” and “second” can be used to describe various components without limiting the components. The terms are used only for distinguishing one component from another component.

It should be understood that when a component is referred to as being “connected to” or “coupled to” another component, it can be directly connected or coupled to the other component or intervening component may be present. In contrast, when a component is referred to as being “directly connected to” or “directly coupled to” another component, there are no intervening component present.

As used herein, the singular forms are intended to include the plural forms as well, unless the context clearly indicates otherwise.

It should be further understood that the terms “comprises” or “has,” when used in this specification, specify the presence of a stated feature, number, step, operation, component, element, or a combination thereof, but they do not preclude the presence or addition of one or more other features, numbers, steps, operations, components, elements, or combinations thereof. When a component, device, element, or the like of the present disclosure is described as having a purpose or performing an operation, function, or the like, the component, device, or element should be considered herein as being “configured to” meet that purpose or to perform that operation or function.

In addition, a unit or control unit included in the names of a Motor Control Unit (MCU), a Hybrid Control Unit (HCU), etc. is only a term in use widely for designating a controller that controls a specific functions of a vehicle but does not mean a generic function unit.

For example, each controller may include a communication device communicating with another controller or sensor to control a function in charge, a memory that stores operating system or logic instructions and input/output information, and one or more processors for determination, operation, and decision-making necessary for functions in charge.

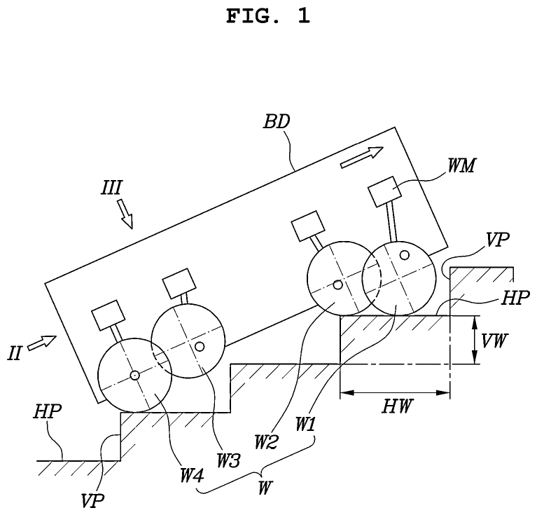

With reference to FIGS. 1 to 3, a stair-climbing vehicle according to an embodiment of the present disclosure includes a body BD, and a plurality of driving wheels W disposed along the front-rear direction of the body BD to be rotatable and movable with respect to the body BD. The stair-climbing vehicle further includes: a wheel position moving device WM provided to actively move the rotation shaft of the driving wheel W with respect to the body BD, and a driving source installed to continuously supply driving force to the driving wheels W while the driving wheels W are moved by the wheel position moving device WM.

In other words, the driving wheel W is driven by the driving force supplied from the driving source while the wheel position moving device WM controls the driving wheel W to actively ascend and descend the stairs, thereby the body BD climbing up and down the stairs.

For reference, a stair is composed of a stair horizontal plane HP and a stair vertical plane VP. A stair width HW refers to the width of the stair horizontal plane HP, and a stair height VW refers to the width of the stair vertical plane VP.

In addition, the stair to which the present disclosure is applied may be a general stair with the stair width HW and the stair height VW never exceeding three times each other (e.g., a ratio of HW to VW is less than 3:1 or vice versa) such that an adult can walk up and down by stepping on both feet alternately, rather than any abnormal stairs of which the stair width HW or the stair height VW exceeds three times each other.

The two paired driving wheels W disposed on the body BD to simultaneously contact the stair horizontal plane HP may have different separation distances from the front-rear center line of the body BD to the rotation axes thereof.

In addition, the two paired driving wheels W disposed on the body BD to simultaneously contact the same stair horizontal plane HP may be disposed to overlap each other at least partially when viewed in the lateral direction of the body BD.

In addition, at least two pairs of the two driving wheels W disposed on the body BD to simultaneously contact the same stair horizontal plane HP may be arranged along the front-rear direction of the body BD.

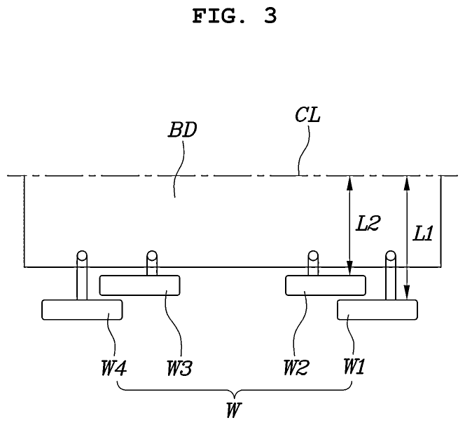

In other words, with reference to FIGS. 1 and 3, a pair of driving wheels W1, W2 is disposed at the front of the body BD and another pair of driving wheels W3, W4 is disposed at the rear side of the body BD. Along the front-rear direction of the body BD, the driving wheels W paired at the front of the body BD have different separation distances (L1 and L2) from the front-rear center line CL of the body BD to the rotation axes thereof so as to at least partially overlap each other when viewed in the lateral direction of the body BD, and the driving wheels W paired at the rear of the body BD are also the same.

The wheel position moving device WM is configured, when the body BD ascends and descends, so as to move the driving wheels W from the currently contacted stair horizontal plane HP to the next stair horizontal plane HP without contacting the stair vertical surface VP therebetween.

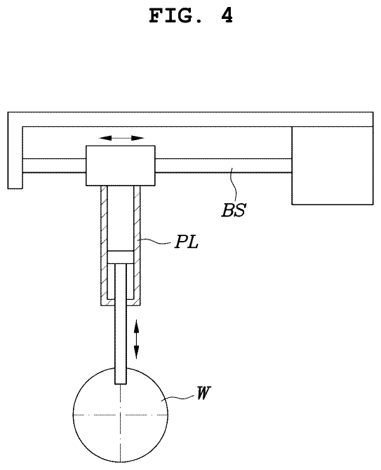

For example, as shown in FIG. 4, the wheel position moving device WM can freely move the driving wheel W on a plane perpendicular to the rotation axis of the driving wheel W using the ball screw BS and the hydraulic cylinder PL. This allows the driving wheels to move from one stair horizontal plane HP to another stair horizontal plane HP in a trajectory without contacting the stair vertical plane VP therebetween.

In addition to the above example, it may also be possible to implement the wheel position moving device WM with only the hydraulic cylinder (PL) or only the ball screw (BS) or using various driving mechanisms such as a worm and a worm wheel, a rack and a pinion, and a link mechanism so as to be able to actively adjust the rotation shaft of the driving wheel W with respect to the body BD.

Here, the ‘implementing the wheel position moving device WM to be able to actively adjust the rotation shaft of the driving wheel W with respect to the body BD’ in the present disclosure means configuring the wheel position moving device WM to be able to actively and continuously change the position of the rotation shaft of the driving wheel W with respect to the body BD regardless of a change in the road surface. These features are different from the conventional vehicle in which the driving wheel W is simply supported by a suspension and moves passively with respect to the body BD according to a change in the road surface.

Meanwhile, the vehicle is provided with sensing equipment such as a camera, lidar or radar capable of sensing or scanning the stairs in order to move the driving wheel W without contacting the stair vertical plane VP via the wheel position moving device WM. The vehicle is also provided with a device for processing the sensed information on the stairs using artificial intelligence (AI) or the like to calculate the movement path of the rotation shaft of the driving wheel in advance.

The wheel position moving device WM may be provided to move the rotation shafts of the driving wheels W independently from each other.

In other words, the wheel position moving device WM may be provided to be identical in number with the driving wheels W such that the rotation shafts of all the driving wheels W provided in the body BD can be individually moved with respect to the body BD.

Meanwhile, the driving wheels W may be provided symmetrically on both sides with respect to the front-rear center line of the body BD.

In this embodiment, it is possible to group the two driving wheels W symmetrically provided on both sides of the body BD into a group so that the wheel position moving device WM can move the driving wheels W of one group together.

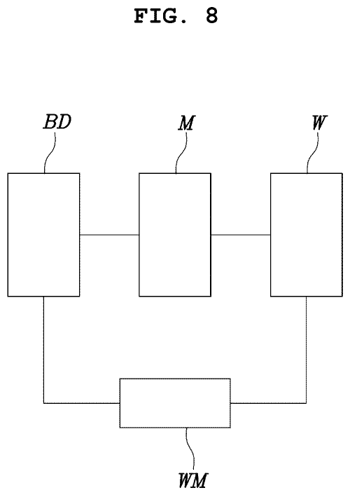

FIG. 8 schematically illustrates the main configuration of the present disclosure. In one embodiment, the driving source may be the motor M, and the motor M is installed to provide a driving force for rotating the driving wheels W with respect to the body BD. The wheel position moving device WM actively moves the driving wheel W with respect to the body BD.

The driving source may be the motor M disposed on the driving wheel W.

In other words, the motor M is configured to be arranged in the driving wheel W like an in-wheel vehicle so as to move along with the driving wheel W when the rotation shaft of the driving wheel W moves with respect to the body BD.

Meanwhile, the driving source may be configured to have a motor M mounted on the body BD.

In this embodiment, given that the motor M is mounted on the body BD and the rotation shaft of the driving wheel W moves with respect to the body BD, the wheel position moving device WM is connected to the wheel support device (U) in order to continuously transmit the driving force of the motor M to the driving wheel W while the rotation shaft of the driving wheel W moves with respect to the body BD.

For reference, the rotation shaft of the driving wheel W and the driving shaft transmitting a driving force from the motor M to the driving wheel W should be distinguished, in other words, the rotation shaft of the driving wheel W, as the geometric center of the driving wheel W, is represented by the intersection point where two straight lines intersect in FIG. 1 while and the driving shaft is represented by a dot in FIG. 1 and double straight lines connecting the body BD to the driving wheel W in FIG. 3.

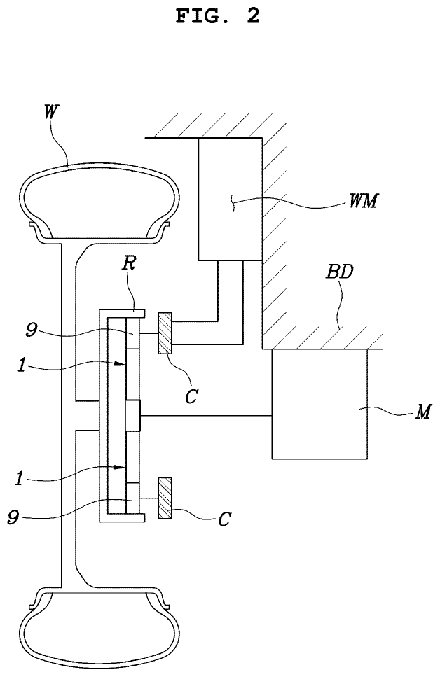

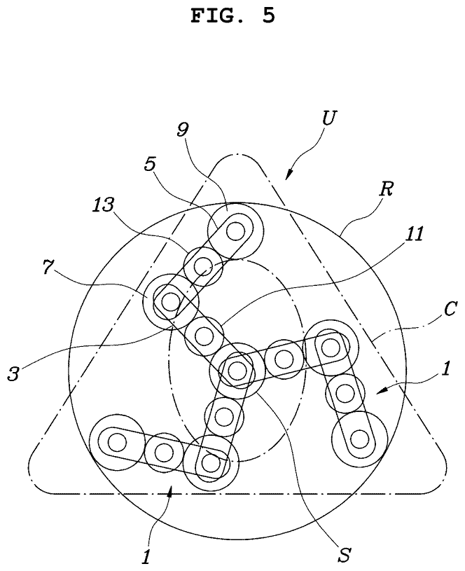

With reference to FIGS. 2 and 5, the wheel support device U is configured to include a ring gear R installed concentrically to the driving wheel W, a sun gear S installed in the ring gear R to receive the driving force from the motor (M), a gear train 1 configured to allow relative motion between the rotation axes of the sun gear S and the ring gear R and to form a continuous driving force transmission state between the sun gear S and the ring gear R, and a carrier C constituting the gear train 1 and constantly supporting the position of the rotation axis of a final pinion 9 engaged with the ring gear R with respect to the position of the rotation axis of the ring gear R.

In one embodiment, the carrier C of the wheel support device U is connected to the wheel position moving device WM such that the rotation axis of the driving wheel W is moved with respect to the body BD according to the operation of the wheel position moving device WM, and the sun gear S continuously transmits the driving force received from the motor M fixed to the body BD to the ring gear R and the driving wheels W through the gear train 1.

The gear train 1 is provided with a plurality of links whose angles connected to each other change according to the relative motion between the rotation shafts of the sun gear S and the ring gear R. In one embodiment, the plurality of links include a first link 3 connected to the sun gear S and a second link 5 connected to the first link 3, and a joint pinion 7 having teeth identical in number with those of the sun gear S is installed at the connecting portion of the first and second links 3 and 5.

The second link 5 is provided with the final pinion 9 engaged with the ring gear R, and the final pinion 9 has teeth identical in number with those of the sun gear S.

Accordingly, the final pinion 9 can transmit driving force from the sun gear S to the ring gear R through a series of gears connected to the joint pinion 7, and all of the sun gear S and the joint and final pinions 7 and 9 have the same number of teeth.

As described above, among the series of gears constituting the gear train 1, both the joint and final pinions 9, which are gears located at the even-numbered positions from the sun gear S, have to have the same number of teeth as the sun gear to achieve relative motion of the ring gear R with respect to the sun gear S without a change in the relative phase of the sun gear and the ring gear R and maintain continuous and stable driving force transmission state between the sun gear S and the ring gear R.

The sun gear S and the joint pinion 7 are engaged with a first intermediate pinion 11 having a rotation shaft installed on the first link 3, and the joint pinion 7 and the final pinion 9 are engaged with the second intermediate pinion 13 having a rotation shaft installed on the second link 5.

Accordingly, the driving force from the sun gear S may be transmitted to the ring gear R through the first intermediate pinion 11, the joint pinion 7, the second intermediate pinion 13, and the final pinion 9 in order.

The gear train 1 may be provided in plurality along the circumferential direction of the sun gear S, and the final pinions 9 of the plurality of gear trains 1 are rotatably supported by the carrier C to keep their relative positions constantly and rotate only on their axis.

The gear train 1 is configured such that the relative phase of the sun gear S and the ring gear R is constantly maintained with respect to the relative motion of the rotation shafts of the sun gear S and the ring gear R.

Here, the expression that the relative phase of the sun gear S and the ring gear R is constantly maintained with respect to the relative motion of the rotation shafts of the sun gear S and the ring gear R may be expressed as the rotation direction phase of the points. PS and PR respectively marked at the 0 degree position of the sun gear S and the ring gear R is constantly maintained at the 0 degree position even when the ring gear R is raised or lowered with respect to the sun gear S.

In other words, when the rotation shafts of the sun gear S and the ring gear R move in translation with each other on the same plane, the sun gear S and the ring gear R do not rotate with each other due to the translational motion itself.

This means that the movement of the ring gear R connected to the driving wheel W, which is caused by the wheel position moving device WM moving the position of the rotation shaft of the driving wheel W with respect to the body BD, does not lead to an additional rotation movement of the sun gear S and makes it easy and stable to control the torque of the sun gear S through the torque control of the motor M connected to the sun gear S.

In order to keep the relative phase between the sun gear S and the ring gear R constant while the ring gear R is moving with respect to the sun gear S, the joint pinion 7 and the final pinion 9, which are the gears located at even-numbered positions from the sun gear S among the series of gears constituting the gear train 1, must have the same number teeth as the sun gear S.

Accordingly, the stair-climbing vehicle of this embodiment moves the driving wheels to the next stair horizontal plane HP without contacting the stair vertical plane VP with the wheel position moving device WM when ascending or descending the stair without cutting off the driving force supply from the motor M mounted on the body BD to the driving wheels W through the sun gear S despite the change in the positions of the driving wheels W with respect to the body BD as such, thereby the body BD ascending and descending the stairs in a smooth and uninterrupted manner.

Although the present disclosure has been illustrated and described in connection with a specific embodiment, it should be apparent to those having ordinary skill in the art that various modification and changes can be made thereto without departing from the spirit of the present disclosure or the scope of the appended claims.

What is claimed is:

1. A stair-climbing vehicle comprising:
a body;
a plurality of driving wheels arranged along a front-rear direction of the body and configured to be rotatable and movable with respect to the body;
a wheel position moving device configured to move rotation shafts of the driving wheels while preventing the plurality of driving wheels from contacting a stair vertical plane; and
a driving source installed to supply driving force to the plurality of driving wheels.

2. The vehicle of claim 1, wherein driving wheels of the plurality of driving wheels are arranged in pairs, and a pair of two driving wheels simultaneously contact a same stair horizontal plane along the front-rear direction of the body.

3. The vehicle of claim 2, wherein the pair of two driving wheels arranged to simultaneously contact the same stair horizontal plane have different separation distances from a front-rear center line of the body to rotation axes thereof.

4. The vehicle of claim 3, wherein the pair of two driving wheels arranged to simultaneously contact the same stair horizontal plane are at least partially overlap each other when viewed in a lateral direction of the body.

5. The vehicle of claim 2, wherein at least two pairs of two driving wheels arranged to simultaneously contact the same stair horizontal plane are disposed along the front-rear direction of the body.

6. The vehicle of claim 1, wherein the wheel position moving device is provided to move the rotation shafts of the driving wheels independently from each other.

7. The vehicle of claim 1, wherein the plurality of driving wheels is provided symmetrically on both sides with respect to a front-rear center line of the body.

8. The vehicle of claim 1, wherein the driving source comprises a motor disposed in the plurality of driving wheels.

9. The vehicle of claim 1, wherein the driving source comprises a motor disposed in the body.

10. The vehicle of claim 9, wherein the wheel position moving device is connected to a wheel support device supporting a driving wheel among the plurality of driving wheels to continuously transmit a driving force from the motor to the driving wheel while the rotation shaft of the driving wheel is moving,
wherein the wheel support device comprises:
a ring gear installed concentrically to the driving wheel;
a sun gear installed in the ring gear to receive driving force from the motor;
a gear train configured to allow relative motion between the rotation shafts of the sun gear and the ring gear and to form a continuous driving force transmission state between the sun gear and the ring gear; and
a carrier constituting the gear train and constantly supporting positions of the rotation shaft of a final pinion engaged with the ring gear with respect to the position of the rotation shaft of the ring gear.

11. The vehicle of claim 10, wherein the gear train is provided with a plurality of links connected to each other to form an angle varying according to a relative motion between the rotation shafts of the sun gear and the ring gear, the plurality of links comprises a first link connected to the rotation shaft of the sun gear and a second link connected to the first link, and a joint pinion having a same number of teeth as the sun gear is installed at a connection point of the first and second links.

12. The vehicle of claim 11, wherein the second link is provided with a final pinion engaged with the ring gear, and the final pinion has the same number of teeth as the sun gear and is configured to transmit a driving force from the sun gear to the ring gear via a series of gears connected to the joint pinion.

13. The vehicle of claim 12, wherein the gear train is provided in plurality along a circumferential direction of the sun gear.

14. The vehicle of claim 10, wherein the gear train is provided with a plurality of links connected to each other to form an angle varying according to a relative motion between the rotation shafts of the sun gear and the ring gear, the plurality of links comprises a first link connected to the rotation shaft of the sun gear and a second link connected to the first link, and the first and second links are provided with rotation shafts of a series of gears to transmit driving force from the sun gear to the ring gear.

15. The vehicle of claim 14, wherein the series of gears constituting the gear train comprises gears positioned at even-numbered positions from the sun gear and having the same number of teeth as the sun gear.

16. The vehicle of claim 15, wherein the gear positioned second from the sun gear is a joint pinion installed concentrically with the rotation shaft of the first and second links, and the gear positioned fourth from the sun gear is the final pinion engaged with the ring gear.

17. The vehicle of claim 16, wherein the sun gear and the joint pinion are engaged with a first intermediate pinion having a rotation shaft installed on the first link, and the joint pinion and a final pinion gear are engaged with a second pinion having a rotation shaft installed on the second link.

18. The vehicle of claim 10, wherein the gear train is provided in plurality along a circumferential direction of the sun gear, and the final pinions of the gear trains are supported by the carrier to keep relative positions constantly and allowed only to rotate.

19. The vehicle of claim 10, wherein the gear train is configured to constantly maintain relative phases of the sun gear and the ring gear with respect to relative motions of the rotation shafts of the sun gear and the ring gear.

20. A stair-climbing vehicle comprising:
a body;
a plurality of driving wheels arranged in pairs, rotatably and moveably with respect to the body, for two paired driving wheels to simultaneously contact a same stair plane along a front-rear direction of the body;
a wheel position moving device provided to actively move rotation shafts of the driving wheels with respect to the body; and
a driving source installed to supply driving force to the driving wheels.
